(19) United States
(12) Patent Application Publication
(10) Pub. No.: US 2025/0313153 A1
(43) Pub. Date: Oct. 9, 2025

(54) SUPPORT ASSEMBLY FOR TAILGATE

(71) Applicant: Ford Global Technologies, LLC, Dearborn, MI (US)

(72) Inventors: Manpreet Bansal, Canton, MI (US); Peter Thai, White Lake, MI (US); Nicholas Turek, Canton, MI (US)

(21) Appl. No.: 18/628,885

(22) Filed: Apr. 8, 2024

(51) Int. Cl. B60R 3/02; B60N 3/02; B62D 33/027

(52) U.S. Cl. CPC B60R 3/02; B60N 3/023; B62D 33/0273

(57) ABSTRACT

A motor vehicle includes a tailgate, a deployable step assembly movable between a stowed position and a deployed position relative to an inner cavity of the tailgate, and a support assembly within the inner cavity. The support assembly is directly attached to the deployable step assembly.

### TECHNICAL FIELD

This disclosure relates to a support assembly for a tailgate of a motor vehicle.

### BACKGROUND

Some vehicles, such as pickup trucks, include a cargo bed. The cargo bed can be located behind a passenger compartment of the vehicle. A tailgate can enclose a rear, or aft, end of the cargo bed. Users use cargo beds to carry various types of loads and/or cargo.

### SUMMARY

In some aspects, the techniques described herein relate to a motor vehicle, including; a tailgate; a deployable step assembly movable between a stowed position and a deployed position relative to an inner cavity of the tailgate; and a support assembly within the inner cavity, wherein the support assembly is directly attached to the deployable step assembly.

In some aspects, the techniques described herein relate to a motor vehicle, wherein, when the deployable step assembly is in the deployed position, a step pad of the deployable step assembly is rearward of and vertically lower than the tailgate.

In some aspects, the techniques described herein relate to a motor vehicle, wherein the deployable step assembly includes a first rail and a second rail configured to support the step pad.

In some aspects, the techniques described herein relate to a motor vehicle, wherein: the deployable step assembly includes a first channel configured to receive the first rail, the deployable step assembly includes a second channel configured to receive the second rail, the support assembly includes at least one support beam directly attached to both the first channel and the second channel.

In some aspects, the techniques described herein relate to a motor vehicle, further including: a deployable handle movable between a stowed position and a deployed position relative to the inner cavity of the tailgate; and a third channel configured to receive the deployable handle, wherein the at least one support beam is directly attached to the third channel.

In some aspects, the techniques described herein relate to a motor vehicle, wherein the at least one support beam includes a first support beam extending in a direction substantially perpendicular to a centerline of the motor vehicle.

In some aspects, the techniques described herein relate to a motor vehicle, wherein the at least one support beam is directly attached to an upper surface of the first and second channels, relative to when the tailgate is an open position.

In some aspects, the techniques described herein relate to a motor vehicle, wherein: the tailgate includes a panel, when the tailgate is in an open position, a first surface of the panel provides an upper surface of the tailgate, and the first support beam directly contacts a second surface of the panel opposite the first surface.

In some aspects, the techniques described herein relate to a motor vehicle, wherein: the at least one support beam includes a second support beam extending in a direction substantially perpendicular to the centerline of the motor vehicle, the at least one support beam includes a third support beam extending in a direction substantially perpendicular to the centerline of the motor vehicle, and the first, second, and third support beams are spaced-apart from one another in a direction substantially parallel to the centerline of the motor vehicle.

In some aspects, the techniques described herein relate to a motor vehicle, wherein the second and third support beams directly contact the second surface of the panel.

In some aspects, the techniques described herein relate to a motor vehicle, wherein: the first, second, and third support beams are directly attached to a plurality of reinforcement beams, and the plurality of reinforcement beams extend substantially parallel to the centerline.

In some aspects, the techniques described herein relate to a method, including: directly attaching a deployable step assembly to a support assembly; and inserting the combined deployable step assembly and support assembly into an inner cavity of a tailgate.

In some aspects, the techniques described herein relate to a method, wherein: the deployable step assembly includes a first channel configured to receive a first rail, the deployable step assembly includes a second channel configured to receive a second rail, and the directly attaching step includes directly attaching at least one support beam of the support assembly to both the first channel and the second channel.

In some aspects, the techniques described herein relate to a method, wherein the directly attaching step includes directly attaching the support assembly to a third channel configured to receive a deployable handle.

In some aspects, the techniques described herein relate to a method, wherein the at least one support beam includes a first support beam directly attached to an upper surface of the first and second channels, relative to when the tailgate is in an open position.

In some aspects, the techniques described herein relate to a method, wherein: the tailgate includes a panel, when the tailgate is in the open position, a first surface of the panel provides an upper surface of the tailgate, and the first support beam directly contacts a second surface of the panel opposite the first surface.

In some aspects, the techniques described herein relate to a method, wherein: the at least one support beam includes a second support beam extending in a direction substantially parallel to the first support beam, the at least one support beam includes a third support beam extending in a direction substantially parallel to the first and second support beams, and the first, second, and third support beams are spaced-apart from one another.

In some aspects, the techniques described herein relate to a method, wherein the second and third support beams directly contact the second surface of the panel.

In some aspects, the techniques described herein relate to a method, wherein: the first, second, and third support beams are directly attached to a plurality of reinforcement beams, and the plurality of reinforcement beams extend substantially perpendicular to the first, second, and third support beams.

### BRIEF DESCRIPTION OF THE DRAWINGS

FIG. 1 is a rear perspective view of a portion of an example motor vehicle with a tailgate in a closed position.

FIG. 2 is a view similar to FIG. 1 with the tailgate in an open position.

FIG. 3 is a view of the tailgate in the open position, a deployable step assembly, including a deployable handle, in a deployed position.

FIG. 4 illustrates the deployable step assembly in a stowed position.

FIG. 5 illustrates a support assembly directly attached to the deployable step assembly of FIG. 4.

FIG. 6 is a view taken along line 6-6 and represents an arrangement of a support beam of the support assembly.

FIG. 7 is a view of the tailgate, with a panel removed for ease of reference, including the deployable step assembly and support assembly.

FIG. 8 illustrates an example assembly process in which the combined deployable step assembly and support assembly are inserted into an inner cavity of the tailgate.

### DETAILED DESCRIPTION

This disclosure relates to a support assembly for a tailgate of a motor vehicle. This disclosure absorbs loads applied to the tailgate, while reducing packaging size, which in turn permits other structures, such as a step pad configured to be stored within the tailgate, to be increased in size. The support assembly of this disclosure is also readily manufactured and assembled. These and other benefits will be appreciated from the following description.

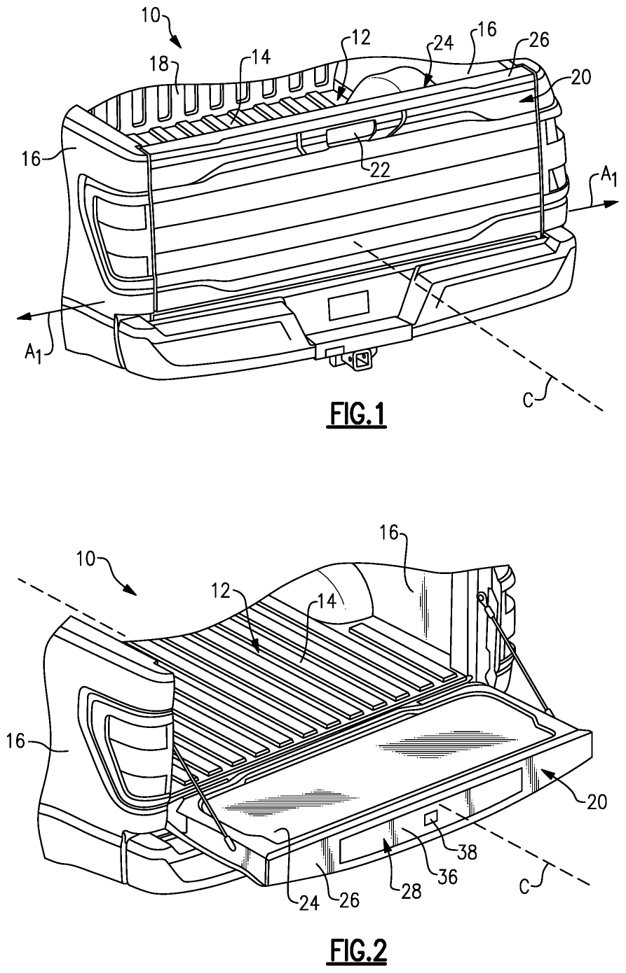

Referring to the drawings, FIG. 1 is a front perspective view of an example motor vehicle 10, which in this example is a pickup truck. While a pickup truck is shown, this disclosure extends to other vehicle types.

In this disclosure, the motor vehicle 10 includes a cargo space for storing and/or hauling one or more items of cargo. In the illustrated embodiment, the cargo space is established by a cargo bed 12 of the pickup truck. While a pickup truck with a cargo bed is specifically depicted and referenced herein, other vehicles having other types of cargo spaces could also benefit from the teachings of this disclosure. The motor vehicle 10 could also be an internal combustion engine powered vehicle, a traction battery powered electric or hybrid vehicle, an autonomous vehicle (i.e., a driverless vehicle), etc.

The cargo bed 12 is generally rearward of a passenger cabin (not shown) of the vehicle 10 and includes a floor 14 extending between a pair of longitudinally extending side walls 16, a laterally extending front wall 18, and a tailgate 20. The tailgate 20 may be referred to as a tailgate assembly. The overall size, shape, and configuration of the cargo bed 12 is not intended to limit this disclosure.

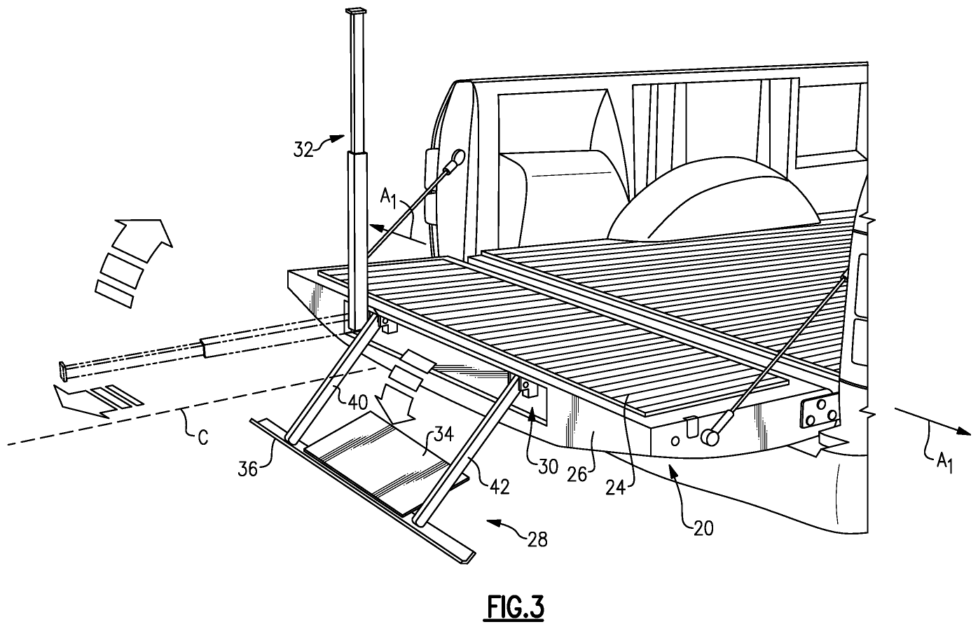

The tailgate 20 is pivotable about a first axis A1 relative to the cargo bed 12 between a closed position shown in FIG. 1 and an open position shown in FIG. 2. The first axis A1 is substantially perpendicular to a centerline C of the motor vehicle 10.

The tailgate 20 may be moved from the closed position to the open position in response to actuating a handle 22 of the tailgate 20, for example. In the closed position, the tailgate 20 encloses an end of the cargo bed 12 that is opposite from the front wall 18. In the open position, the tailgate 20 is rotated substantially 90° relative to the closed position, and allows access to the cargo bed 12 from the rear.

The tailgate 20, in this disclosure, includes a plurality of panels connected to provide the overall structure of the tailgate 20. Within the panels, the tailgate includes an inner cavity. Among other panels, the tailgate 20 includes a panel 24 and a panel 26. When the tailgate 20 is in the closed position, the panel 24 provides a front-facing surface of the tailgate 20, and when the tailgate 20 is in the open position, the panel 24 provides an upper surface of the tailgate 20, which can be used as a work surface, for example. When the tailgate 20 is in the closed position, the panel 26 provides an upper surface of the tailgate 20, and when the tailgate is in the open position, the panel 26 provides a rear-facing surface of the tailgate 20.

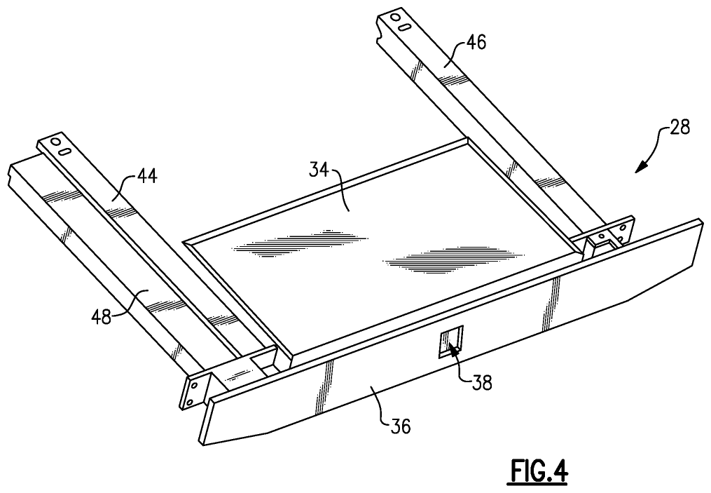

A user may require assistance for stepping up and accessing the cargo bed 12 from the ground. This disclosure includes a deployable step assembly 28. The deployable step assembly 28 is movable between a stowed position (FIG. 2) and a deployed position (FIG. 3) relative to an inner cavity 30 of the tailgate 20. The inner cavity 30 is a space within the tailgate 20 and is enclosed by the panels of the tailgate 20. Specifically, panels 24 and 26 partially enclose the inner cavity 30. The deployable step assembly 28 further includes a deployable handle 32 movable between a stowed position (FIG. 2) and a deployed position (FIG. 3) relative to the inner cavity 30. When moving from the stowed position to the deployed position, the deployable step assembly 28 moves generally rearwardly and downwardly, in this example, with the exception of the deployable handle 32, which moves generally rearwardly and upwardly, in this example. When in the deployed position, the deployable handle 32 is in a location that is able to be grasped by a hand of a user while the user is using the deployable step assembly 28 to enter or exit the cargo bed 12. The deployable handle 32 may be part of a deployable handle assembly, and may be considered part of the deployable step assembly 28. The deployable step assembly 28 does not include a deployable handle in some embodiments.

With reference to FIGS. 3 and 4, the deployable step assembly 28 includes a step pad 34 configured to support a foot, or feet, of a user from below. The step pad 34 is connected to a cover 36, which extends in a direction substantially perpendicular to a centerline C of the motor vehicle 10. The cover 36 is configured to sit flush with the panel 26 and enclose the inner cavity 30 when the deployable step assembly 28 is in the stowed position. A button 38 may be configured to selectively release the deployable step assembly 28 from the stowed position.

The cover 36 is connected to first and second rails 40, 42. When the deployable step assembly 28 is in the deployed position, the first and second rails 40, 42 are configured to support the cover 36, and in turn the step pad 34, such that the step pad 34 is rearward of and vertically lower than the tailgate 20. The first and second rails 40, 42 are slidable relative to first and second channels 44, 46, respectively, of the deployable step assembly 28. When the deployable step assembly 28 is in the stowed position, the first channel 44 is configured to receive the first rail 40, and the second channel 46 is configured to receive the second rail 42. The first and second channels 44, 46 are provided by substantially hollow tubes, which exhibit a cross-section substantially matching that of the first and second rails 40, 42. The first and second channels 44, 46 are fixedly mounted within the inner cavity 30, in this example.

Further, this disclosure includes a third channel 48 within the inner cavity 30. The third channel 48 is configured to receive the deployable handle 32 when the deployable handle 32 is in the stowed position. The third channel 48 is provided by a substantially hollow tube, which exhibits a cross-section substantially matching that of the deployable handle 32. The third channel 48 is fixedly mounted within the inner cavity 30, in this example.

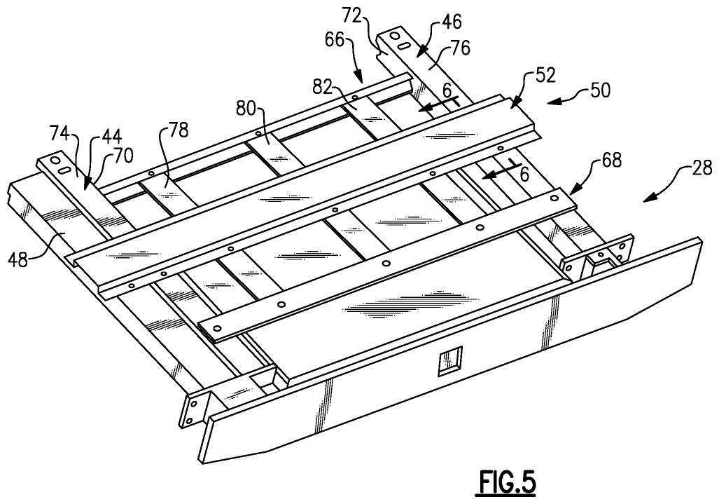

With reference to FIG. 5, a support assembly 50 is directly attached to the deployable step assembly 28. The support assembly 50 is configured to reinforce the panel 24 and spread loads applied to the panel 24 such that those loads can be effectively absorbed by the tailgate 20. In this disclosure, the term directly attached, such as how that term is used relative to the support assembly 50 and the deployable step assembly 28, means at least a portion of the support assembly 50 is both in contact with and directly affixed to at least a portion of the deployable step assembly 28, for example. The support assembly 50 may be directly affixed to the deployable step assembly 28 using one or more of fasteners, such as nuts, bolts, rivets, etc., or by welding, for example.

The support assembly 50 includes at least one support beam directly attached to both the first channel and the second channel 44, 46. Specifically, in this example, the support assembly 50 includes a first support beam 52 extending in a direction substantially perpendicular to a length dimension of the first and second channels 44, 46, and, when mounted to the motor vehicle 10, is substantially perpendicular to the centerline C. The first support beam 52 is substantially U-shaped in cross-section, and in particular resembles an upside-down U-shape in this example. While the first support beam 52 is substantially U-shaped in this embodiment, the first support beam 52 could be shaped differently, including being substantially L-shaped or being configured as a substantially flat plate.

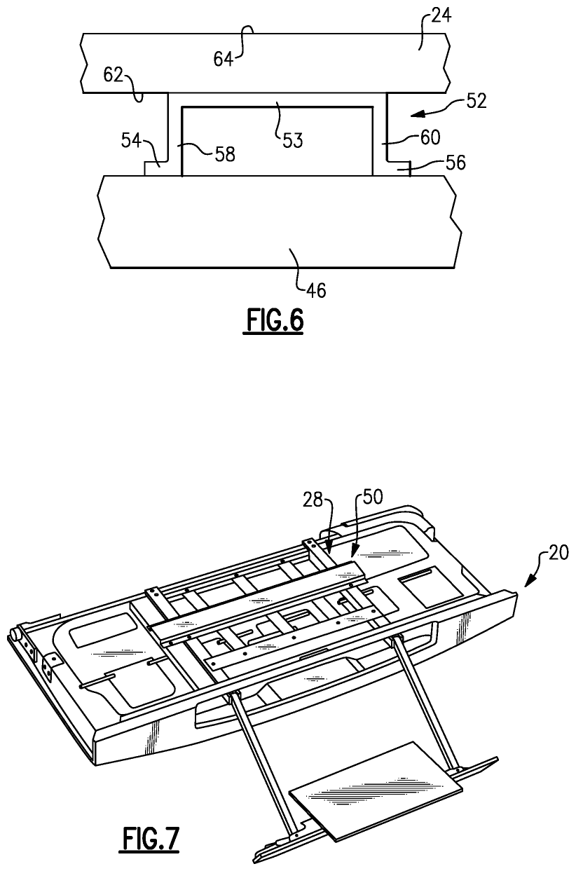

With reference to FIG. 6, which shows the first support beam 52 in cross-section, the first support beam 52 includes a first wall 53, first and second feet 54, 56 extending substantially parallel to the first wall 53, and first and second walls 58, 60 extending between the first wall 53 and the first and second feet 54, 56, respectively. The first support beam 52 is directly attached to upper surfaces of the first channel 44, second channel 46, and in this example is also directly attached to the third channel 48 via the first and second feet 54, 56. While the first support beam 52 is directly attached to the first, second, and third channels 44, 46, 48 in this example, in other examples the first support beam 52 could be directly attached to any two of the first, second, and third channels 44, 46, 48.

Further, as shown in FIG. 6, the first wall 53 is in direct contact with a surface 62 of the panel 26 opposite the surface 64 that provides the upper surface of the tailgate 20 when the tailgate 20 is in the open position. The surface 64 may be covered with one or more layers of material, such as rubber or plastic, in an example, while still being considered the upper surface of the tailgate 20. Therefore, the first support beam 52 transfers loads applied to the panel 26 to other structures of the tailgate 20, including the first, second, and/or third channels 44, 46, 48.

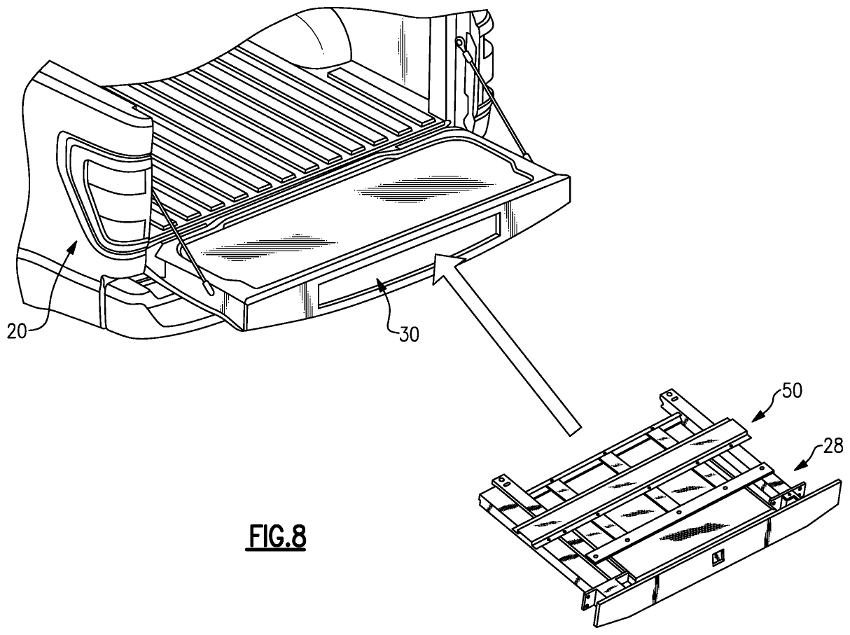

In an example, in addition to the first support beam 52, the support assembly 50 includes at least one additional support beam. In a particular example, the support assembly 50 includes a second support beam 66 extending in a direction substantially parallel to the first support beam 52. Further, the support assembly 50 includes a third support beam 68 extending in a direction substantially parallel to the first and second support beams 52, 66. Relative to when the deployable step assembly 28 and support assembly 50 are mounted to the motor vehicle 10 (as shown in FIG. 7), the second support beam 66 is spaced-apart from the first support beam 52 in a direction substantially parallel to the centerline C, which in this example is a forward direction, and the third support beam 68 is spaced-apart from the first support beam 52 in the opposite direction as the second support beam 66.

The second support beam 66 is substantially L-shaped in cross-section in this example. Further, the second support beam 66 extends between a surface 70 of the first channel 44 facing the second channel 46, and a surface 72 of the second channel 46 facing the first channel 44. The third support beam 68 is configured as a substantially flat plate, and extends between a surface 74 of the first channel 44 and a surface 76 of the second channel 46. The surfaces 74, 76 face in the upward direction when the tailgate 20 is in the open position. The second and third support beams 66, 68 can be configured to contact the surface 62 of the panel 24. The second and third support beams 66, 68 are not limited to being configured as being substantially L-shaped or as substantially flat plates, respectively. The second and third support beams 66, 68 could be configured so as to be substantially U-shaped in cross-section, similar to the first support beam 52, or could be configured in another manner. Further, in other examples, the second support beam 66 could be directly attached to surfaces 74, 76 as opposed to surfaces 70, 72, and the third support beam 68 could be directly attached to surfaces 70, 72 as opposed to surfaces 74, 76. The second and third support beams 66, 68 could also be directly attached to the third channel 48 in other examples.

The support assembly 50 further includes a plurality of reinforcement beams, in this disclosure. In this example, three reinforcement beams 78, 80, 82 are directly attached to each of the first, second, and third support beams 52, 66, 68. The reinforcement beams 78, 80, 82 provide rigidity to the support assembly 50. When mounted to the motor vehicle 10, the reinforcement beams 78, 80, 82 extend substantially parallel to the centerline C. While three reinforcement beams 78, 80, 82 are shown, this disclosure extends to other quantities of reinforcement beams. Together, the first, second, and third support beams 52, 66, 68 and the reinforcement beams 78, 80, 82 may resemble a lattice, and can be referred to as a lattice structure or a frame. The arrangement of the support assembly 50 is such that the usable space of the inner cavity 30 is increased relative to known designs, and, as such the step pad 34 can exhibit a larger size, and greater surface area, relative to known step pads, while still fitting within the inner cavity 30 when the deployable step assembly 28 is in the stowed position.

In an aspect of this disclosure, the support assembly 50 can be directly attached to the deployable step assembly 28 before the support assembly 50 and the deployable step assembly 28 are mounted to the tailgate 20, as generally shown in FIG. 8. With the support assembly 50 attached to the deployable step assembly 28, as generally shown in FIG. 8, the combined support assembly 50 and deployable step assembly 28 can be mounted relative to the tailgate 20 by being inserted into the inner cavity 30. In this respect, this disclosure increases the ease of assembly and manufacturing of the deployable step assembly 28 and the support assembly 50.

It should be understood that directional terms such as “bottom,” “top,” “forward,” “rearward,” “upward,” “downward,” etc., are used for purposes of explanation only and should not be deemed limiting. Further, it should be understood that terms such as “about,” “substantially,” and “generally” are not intended to be boundaryless terms, and should be interpreted consistent with the way one skilled in the art would interpret those terms. It should be understood that certain aspects of the disclosure are exaggerated in the Figures for purposes of illustration only.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A motor vehicle, comprising;
a tailgate;
a deployable step assembly movable between a stowed position and a deployed position relative to an inner cavity of the tailgate; and
a support assembly within the inner cavity, wherein the support assembly is directly attached to the deployable step assembly.

2. The motor vehicle as recited in claim 1, wherein, when the deployable step assembly is in the deployed position, a step pad of the deployable step assembly is rearward of and vertically lower than the tailgate.

3. The motor vehicle as recited in claim 2, wherein the deployable step assembly includes a first rail and a second rail configured to support the step pad.

4. The motor vehicle as recited in claim 3, wherein:
the deployable step assembly includes a first channel configured to receive the first rail,
the deployable step assembly includes a second channel configured to receive the second rail,
the support assembly includes at least one support beam directly attached to both the first channel and the second channel.

5. The motor vehicle as recited in claim 4, further comprising:
a deployable handle movable between a stowed position and a deployed position relative to the inner cavity of the tailgate; and
a third channel configured to receive the deployable handle,
wherein the at least one support beam is directly attached to the third channel.

6. The motor vehicle as recited in claim 4, wherein the at least one support beam includes a first support beam extending in a direction substantially perpendicular to a centerline of the motor vehicle.

7. The motor vehicle as recited in claim 6, wherein the at least one support beam is directly attached to an upper surface of the first and second channels, relative to when the tailgate is an open position.

8. The motor vehicle as recited in claim 6, wherein:
the tailgate includes a panel,
when the tailgate is in an open position, a first surface of the panel provides an upper surface of the tailgate, and
the first support beam directly contacts a second surface of the panel opposite the first surface.

9. The motor vehicle as recited in claim 8, wherein:
the at least one support beam includes a second support beam extending in a direction substantially perpendicular to the centerline of the motor vehicle,
the at least one support beam includes a third support beam extending in a direction substantially perpendicular to the centerline of the motor vehicle, and
the first, second, and third support beams are spaced-apart from one another in a direction substantially parallel to the centerline of the motor vehicle.

10. The motor vehicle as recited in claim 9, wherein the second and third support beams directly contact the second surface of the panel.

11. The motor vehicle as recited in claim 9, wherein:
the first, second, and third support beams are directly attached to a plurality of reinforcement beams, and
the plurality of reinforcement beams extend substantially parallel to the centerline.

12. A method, comprising:
directly attaching a deployable step assembly to a support assembly; and
inserting the combined deployable step assembly and support assembly into an inner cavity of a tailgate.

13. The method as recited in claim 12, wherein:
the deployable step assembly includes a first channel configured to receive a first rail,
the deployable step assembly includes a second channel configured to receive a second rail, and
the directly attaching step includes directly attaching at least one support beam of the support assembly to both the first channel and the second channel.

14. The method as recited in claim 13, wherein the directly attaching step includes directly attaching the support assembly to a third channel configured to receive a deployable handle.

15. The method as recited in claim 13, wherein the at least one support beam includes a first support beam directly attached to an upper surface of the first and second channels, relative to when the tailgate is in an open position.

16. The method as recited in claim 15, wherein:
the tailgate includes a panel,
when the tailgate is in the open position, a first surface of the panel provides an upper surface of the tailgate, and
the first support beam directly contacts a second surface of the panel opposite the first surface.

17. The method as recited in claim 16, wherein:
the at least one support beam includes a second support beam extending in a direction substantially parallel to the first support beam,
the at least one support beam includes a third support beam extending in a direction substantially parallel to the first and second support beams, and
the first, second, and third support beams are spaced-apart from one another.

18. The method as recited in claim 17, wherein the second and third support beams directly contact the second surface of the panel.

19. The method as recited in claim 17, wherein:
the first, second, and third support beams are directly attached to a plurality of reinforcement beams, and
the plurality of reinforcement beams extend substantially perpendicular to the first, second, and third support beams.
